(19) United States
(12) Patent Application Publication
(10) Pub. No.: US 2026/0169812 A1
(43) Pub. Date: Jun. 18, 2026

(54) Deterministic Control of Artificial Intelligence Execution at the Operating-System Level

(71) Applicant: Shane W. Robinson, Portsmouth, VA (US)

(72) Inventor: Shane W. Robinson, Portsmouth, VA (US)

(73) Assignee: Titan IP Holdings, LLC, Chesapeake, VA (US)

(21) Appl. No.: 19/460,599

(22) Filed: Jan. 27, 2026

(51) Int. Cl. G06F 9/50

(52) U.S. Cl. CPC G06F 9/5027

(57) ABSTRACT

Systems and methods are disclosed for operating-system-level deterministic identification and control of artificial intelligence (AI) execution on a computing device. Operating-system execution signals generated during application execution are collected and evaluated against a machine-evaluable AI execution pathway definition comprising trigger event types, a bounded temporal evaluation window, a mandatory signal set, ordering constraints, temporal correlation constraints, and exclusion conditions. A binary pathway match outcome is determined based on satisfaction of the execution pathway definition independent of executable identity, content inspection, or network traffic analysis. Upon determination of a pathway match, a machine-enforceable execution control instruction is generated and applied using a kernel-mediated execution control interface, including pre-initialization and in-execution gating operations that prevent, restrict, suspend, sandbox, or otherwise constrain AI-associated execution contexts. The disclosed approach enables selective governance of AI functionality within otherwise permitted applications while preserving non-AI application operation.

### FIELD OF THE INVENTION

The present invention relates generally to computer security, endpoint execution control, and artificial intelligence governance. More specifically, the invention pertains to systems and methods for preventing, restricting, or conditionally controlling execution of artificial intelligence (AI) tools on a computing device using operating-system-level execution signals, without inspecting content, network traffic, or user inputs.

### BACKGROUND OF THE INVENTION

Artificial intelligence (AI) tools capable of generating text, code, images, and recommendations are increasingly integrated into desktop applications, operating systems, development environments, and cloud-assisted software platforms. While these tools provide substantial productivity benefits, their execution introduces operational, security, compliance, and governance risks in regulated, secure, academic, and controlled computing environments.

Existing approaches for controlling or monitoring AI functionality typically rely on network-based inspection, content analysis, browser-specific controls, or cloud telemetry. Such approaches are ineffective against locally executed AI tools, embedded AI runtimes, or operating-system-integrated AI features. Additionally, content inspection techniques raise privacy concerns and often operate only after AI execution has already begun.

Conventional endpoint detection and response (EDR) and data loss prevention (DLP) systems are primarily designed for post-execution detection, alerting, or data exfiltration control. These systems are not architected to provide deterministic pre-execution or in-execution governance of artificial intelligence functionality based on operating-system-level execution behavior, and instead rely on inspection of content, payloads, or network activity.

Traditional endpoint security models operate at an application boundary, treating each application as a monolithic execution unit. Once an application is identified and permitted to run, all functionality within that application, whether related to artificial intelligence or non-AI tasks, is implicitly allowed. This coarse-grained approach fails to account for the internal complexity of modern software, in which AI-enabled features may be invoked selectively and dynamically alongside non-AI functionality.

Modern applications frequently embed or invoke AI capabilities through auxiliary processes, background services, plug-ins, embedded runtimes, or feature-specific execution contexts. Existing security and monitoring systems identify and control software using static characteristics such as executable names, file hashes, publisher certificates, or reputational data. These systems do not evaluate dynamic, context-dependent execution behavior and therefore cannot reliably distinguish AI-related execution from non-AI execution occurring within the same application session.

As a result, AI execution occurring within multifunctional applications often goes undetected, or alternatively causes entire applications to be blocked or disrupted when AI functionality is present. This overinclusive enforcement disables legitimate non-AI functionality and proves ineffective for managing AI tools that operate dynamically at the process, thread, or service level within a single execution environment.

For example, an integrated development environment may provide traditional code editing, compilation, and debugging features while also offering AI-powered code completion or suggestion capabilities. Under conventional application-level control models, the presence of AI functionality may result in blocking the entire development environment, unnecessarily disabling non-AI features that are otherwise permissible and essential.

Existing endpoint security, monitoring, and governance systems therefore lack a mechanism for identifying, defining, and governing a distinct execution construct corresponding specifically to artificial intelligence functionality independent of application identity. There is no existing framework for determining AI execution based on correlated operating-system-level execution signals, nor for selectively applying enforcement actions to AI-associated execution contexts while preserving operation of non-AI components within the same application.

Artificial intelligence execution is often initiated dynamically during runtime and may involve transient processes, threads, services, or execution contexts that are not represented by static application identifiers. Conventional EDR, DLP, and application control systems do not differentiate between AI-specific execution behavior and non-AI execution behavior occurring concurrently, resulting in either failure to detect AI execution or excessive disruption of legitimate software operation.

Accordingly, existing systems are fundamentally limited in their ability to govern artificial intelligence functionality embedded within modern applications using operating-system-level execution behavior. These limitations necessitate a new technical approach capable of identifying and governing AI execution at runtime without reliance on content inspection, network visibility, or static application identifiers.

As used herein, the term “AI-associated” refers to a process, thread, service, execution context, or runtime component that satisfies a machine-evaluable AI execution definition based on operating-system-level execution signals. The term does not require identification of a specific AI model, framework, vendor, executable identity, file hash, certificate, or publisher.

The foregoing background discussion is provided solely to illustrate technical limitations of existing systems and is not intended to suggest that such systems disclose, teach, or render obvious the execution constructs, temporal evaluation mechanisms, or operating-system-level execution control techniques described herein.

Accordingly, there exists a technical need for a system capable of preventing or constraining artificial intelligence execution at runtime using operating-system-level control mechanisms, while preserving operation of non-AI functionality within the same application environment.

### SUMMARY OF THE INVENTION

Conventional endpoint controls operate at the application boundary, focusing on the identification and management of entire applications based on characteristics such as application identity, process name, or window title. These systems typically seek to block, quarantine, or restrict entire applications from executing on a computing device based on predefined security policies. Such approaches, while useful in certain contexts, are limited because they fail to differentiate between the various components or functionalities within an application, thus often overreaching and blocking non-AI functionalities that may be necessary or benign.

Even in embodiments where no operating-system-level execution control action is applied, identification of an AI Execution Pathway improves operation of the computing device by enabling deterministic execution readiness, auditability, policy compliance validation, and enforcement preparedness without inspecting content, network traffic, or executable code, thereby reducing system overhead and preserving user privacy.

The disclosed system does not merely determine, recommend, or advise governance states for AI execution. Rather, the system directly modifies operating-system execution state by invoking kernel-mediated execution control interfaces that prevent, delay, suspend, constrain, or selectively terminate AI-associated execution contexts. Such control operations include, without limitation, preventing completion of process initialization, suspending execution threads, modifying access tokens or privilege contexts, applying constrained execution or sandbox profiles, and disabling AI-associated services or feature hosts. These operating-system-level state changes constitute concrete technical effects that improve operation of the computing device itself by deterministically controlling AI execution behavior rather than merely evaluating or labeling such behavior.

The policy store defines machine-evaluable execution constraints that are enforced through operating-system execution control interfaces to directly modify execution state, and do not represent human-readable rules, advisory policies, or subjective governance logic.

The disclosed system, however, operates at the AI execution pathway boundary. It does not simply block an application based on its identity or title but instead focuses on the specific execution pathways associated with AI functionality within the application. This approach enables granular control over the execution of AI tools, allowing for precise governance of AI-related behaviors while leaving non-AI functionality unaffected. The distinction between application-level control and AI execution pathway control is pivotal in ensuring that only AI-specific actions are regulated, without disrupting the core functionalities of the underlying application or system.

The present invention provides a system and method for local prevention, restriction, and control of artificial intelligence execution on a computing device. The system operates by evaluating operating-system-level execution signals within a bounded temporal evaluation window initiated by a trigger event type, determining a pathway match outcome for an AI execution pathway based on a mandatory signal set with ordering constraints, temporal correlation constraints, and exclusion conditions, and generating an execution control instruction when the pathway match outcome indicates a match.

In all embodiments, determination of whether an AI Execution Pathway exists is performed exclusively through satisfaction of a mandatory signal set, ordering constraints, temporal correlation constraints, and exclusion conditions defined by a machine-evaluable execution pattern definition. Confidence scoring is not used to determine presence or absence of an AI Execution Pathway and does not cause a pathway match. Confidence scoring is applied only after a binary pathway match outcome is determined, solely for selecting among enforcement actions or governance responses following such determination.

In one embodiment, the system monitors operating-system-level signals including at least process creation events and execution context attributes comprising at least one of runtime dependency load attributes, privilege context attributes, invocation pathway attributes, or service interaction attributes, and generates AI execution indicators from normalized versions of such signals.

In one embodiment, after a pathway match indicates a match, the system generates a machine-enforceable execution control instruction and applies an operating-system-level control operation prior to or during AI execution, thereby constraining AI-enabled execution while preserving non-AI operation and without inspecting user content, network traffic, or user inputs.

In certain embodiments, the disclosed system is configured to identify, determine, and classify execution of AI functionality on a computing device based on operating-system-level execution signals, independent of whether any execution control, restriction, or enforcement action is applied. In such embodiments, the system determines presence, absence, or category of AI execution by evaluating execution behavior against an AI execution pathway definition and may operate in an identification-only or monitoring mode.

The disclosed execution governance system is categorically distinct from EDR, DLP, malware detection, and application whitelisting systems, and is not intended to detect maliciousness.

### BRIEF DESCRIPTION OF THE DRAWINGS

FIG. 1 illustrates an exemplary embodiment of a system architecture diagram showing components configured to locally determine and enforce AI execution governance on a computing device.

FIG. 2 illustrates one embodiment of an operating system signal collection module diagram depicting operating-system-level execution signals used to identify attempted or ongoing AI execution without inspecting content or network traffic.

FIG. 3 illustrates an exemplary embodiment of a Confidence Scoring Engine depicting aggregation of AI execution indicators and comparison against governance thresholds to assist in selecting among AI execution governance actions after an AI Execution Pathway match has been determined.

FIG. 4 illustrates one embodiment of an AI tool classification and prevention attribution flowchart showing association of execution evidence with AI tools, AI categories, or AI execution patterns for governance determination.

FIG. 5 illustrates an exemplary embodiment of an execution control engine decision diagram showing generation of machine-enforceable AI execution governance decisions based on a binary AI Execution Pathway match outcome, and further informed by confidence scores, attribution results, contextual inputs, and policy conditions.

FIG. 6 illustrates one embodiment of an AI prevention and enforcement actions flowchart showing operating-system-level execution control actions applied to prevent, restrict, suspend, or terminate AI execution.

### DETAILED DESCRIPTION OF INVENTION

Conventional endpoint control systems are incapable of deterministically governing execution of artificial intelligence (AI) functionality embedded within local applications, operating systems, or runtime environments without relying on inspection of content, network traffic, or executable code. Inspection-based approaches can introduce latency, privacy exposure, and enforcement gaps, particularly for locally executed or offline AI functionality.

The disclosed system provides a deterministic, operating-system-level execution governance mechanism that evaluates AI-specific execution pathways derived from operating-system execution signals and enforces execution control actions through operating-system control interfaces.

As used herein, the policy store comprises one or more machine-readable data structures defining execution constraints that are enforced through operating-system execution control interfaces. The policy store does not implement human-readable rules, advisory logic, or abstract governance decisions, and directly drives operating-system-level execution state modification.

As used herein, an “AI execution pathway” refers to a machine-evaluable execution pattern definition. In one embodiment, the definition includes: (i) at least one trigger event type that initiates evaluation, (ii) a bounded temporal evaluation window, (iii) a mandatory signal set, (iv) one or more ordering constraints, (v) one or more temporal correlation constraints, and (vi) at least one exclusion condition.

As used herein, a “pathway match outcome” refers to a determination indicating whether observed operating-system-level execution signals satisfy a defined AI execution pathway. The terms “pathway match” and “pathway match outcome” may be used interchangeably unless context requires otherwise.

The disclosed architecture improves operation of a computing device by enabling pre-execution and in-execution governance of AI functionality with reduced latency and improved privacy relative to inspection-based controls. In particular, the system enables targeted governance of AI-associated processes, threads, services, or execution contexts, rather than applying coarse-grained control at an application boundary.

In one embodiment, the system limits evaluation to normalized operating-system-level execution signals observed within the bounded temporal evaluation window. The system further improves usability and stability by enabling enforcement against AI-associated execution contexts while permitting non-AI components of the same application session to continue executing.

In some embodiments the system operates in an identification-only or monitoring mode without applying an operating-system-level execution control action. Even in such embodiments, the system improves computing device operation by enabling deterministic execution readiness validation, policy compliance verification, enforcement preparedness, and auditability based on operating-system execution signals without inspecting content, network traffic, executable code, user inputs, prompts, responses, or AI-generated output.

The present invention is not directed to detection, identification, or classification of malicious software, viruses, exploits, or other forms of malware. The AI tools addressed by the disclosed embodiments may be trusted, benign, authorized, and non-malicious in nature.

The disclosed system performs execution gating prior to or during execution of AI-associated functionality. Unlike systems that collect operating-system telemetry primarily for retrospective analysis, alerting, or threat classification, the disclosed system applies bounded pathway evaluation to generate machine-enforceable execution control decisions that modify execution state prior to completion of initialization or while execution is ongoing, depending on implementation.

The system prevents, restricts, or conditions execution of AI functionality based on contextual governance requirements and execution conditions observable at runtime, rather than relying on security threat identification, payload inspection, signature matching, behavioral malware heuristics, or post-execution remediation.

The disclosed system also differs from conventional application control, software restriction, and executable whitelisting systems, which govern software execution by evaluating static executable identity attributes such as hash values, publisher certificates, file paths, package identifiers, reputation scores, or allow/deny lists. Such systems typically allow or block the launch of a discrete executable or package and do not determine whether a permitted application invokes embedded AI functionality during runtime.

In contrast, the disclosed embodiments govern execution based on AI-specific execution characteristics observable at the operating-system level, including, without limitation, combinations of execution context attributes, runtime dependency loading sequences, invocation pathways, service interactions, and windowing or foreground-state behaviors that collectively indicate AI-enabled functionality independent of executable identity.

Application control systems that permit a general-purpose application to execute (e.g., an office suite, integrated development environment, browser, or operating-system component) typically permit the full feature set of that application, including embedded AI assistants, plug-ins, or AI-backed functionality that may be invoked after launch. The disclosed system addresses this technical gap by enabling pre-execution and in-execution AI execution governance, wherein AI-associated execution pathways may be detected upon attempted invocation of AI functionality and restricted, suspended, sandboxed, or prohibited even when the host application itself is otherwise permitted to execute.

In some embodiments, the disclosed system may operate in an environment that also includes conventional application control or allow listing controls. Such controls are not required to practice the invention and do not replace the AI execution governance determinations described herein. The disclosed system is complementary in that it governs AI-enabled execution pathways that may occur within otherwise permitted software.

To enable such governance, the disclosed system defines the AI Execution Pathway as a distinct execution construct corresponding to AI-enabled functionality within an executing application or execution context, determined using operating-system-level execution signals rather than static application identity.

Existing endpoint security, application control, and behavioral monitoring systems do not identify, define, or govern AI execution pathways as distinct enforceable execution constructs. In particular, prior systems generally cannot: (a) identify AI execution occurring within an otherwise permitted application without inspecting content or code; (b) selectively restrict AI-associated execution while allowing non-AI functionality of the same application to continue executing; (c) generate deterministic execution gating decisions based on normalized operating-system-level execution signals independent of executable identity; or (d) enforce controls tied to AI invocation behavior rather than application launch behavior.

The execution governance architecture disclosed herein is not achieved by merely combining endpoint telemetry collection with a generic policy engine or conventional application control framework. Absent a bounded AI execution pathway definition comprising mandatory signal sets, ordering constraints, temporal correlation constraints, and exclusion conditions evaluated prior to or during execution, conventional combinations cannot deterministically intercept and govern AI-associated execution contexts within an otherwise permitted application session without over blocking or reliance on post-execution disruption.

As used herein, the term “deterministic” refers to repeatability of pathway determination and enforcement under identical evaluation conditions. In one embodiment, when an identical normalized set of operating-system-level execution signals is observed within an identical defined temporal evaluation window, and an identical set of policy rules, thresholds, and execution pattern definitions is applied, the system produces an identical pathway match or non-match outcome and generates an identical machine-enforceable execution control instruction, even where a confidence score is computed as an intermediate value.

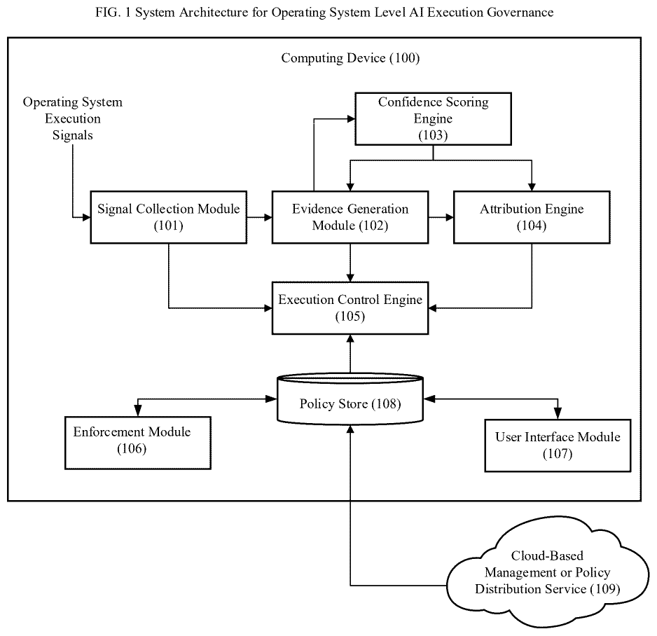

As illustrated in FIG. 1, the system comprises a plurality of interoperating components configured to prevent, restrict, or condition execution of artificial intelligence (AI) tools using operating-system-level execution control mechanisms.

The system architecture separates AI execution pathway determination from confidence scoring and from enforcement application. In one embodiment, a pathway match engine produces a binary pathway match or non-match outcome based on satisfaction of mandatory signals, ordering constraints, temporal correlation constraints, and exclusion conditions. Confidence scoring, when employed, is used only as an intermediate input for selecting among enforcement actions after a pathway match has been determined and does not itself determine whether an AI Execution Pathway exists.

In the illustrated embodiment, a computing device (100) includes a Signal Collection Module (101) configured to collect execution-related signals generated by the operating system, and an Evidence Generation Module (102) configured to derive AI execution indicators from such signals based on execution characteristics associated with AI-enabled functionality.

A Confidence Scoring Engine (103) is configured to evaluate AI execution relevance relative to configured governance policies, and an Attribution Engine (104) is configured to associate execution evidence with specific AI tools, AI tool categories, or AI execution patterns when attribution is required.

An Execution Control Engine (105) is configured to determine an AI execution governance state and generate machine-enforceable execution control decisions, and an Enforcement Module (106) is configured to apply such decisions using operating-system-level execution control mechanisms.

A User Interface Module (107) may present execution governance status, alerts, audit information, or administrative controls to an end user or administrator.

In one embodiment, the system includes a policy store (108) configured to maintain one or more machine-evaluable governance policies used by the Execution Control Engine (105) to determine artificial intelligence (AI) execution governance states. The policy store (108) comprises a structured data repository containing policy definitions, execution pathway definitions, mandatory signal sets, ordering constraints, temporal correlation constraints, exclusion conditions, confidence thresholds, governance state mappings, and enforcement condition parameters.

In one embodiment, the policy store (108) is implemented as a local, read-optimized data store resident on the computing device, enabling deterministic, low-latency evaluation of AI execution governance decisions without reliance on network connectivity, cloud services, or external policy queries. Policy data stored within the policy store (108) is machine-readable and formatted to support direct evaluation by the Execution Control Engine (105) without human interpretation or advisory logic.

The Execution Control Engine (105) accesses the policy store (108) via a Policy Condition Input Interface to retrieve applicable governance rules, thresholds, and execution constraints corresponding to a detected AI Execution Pathway. Policy evaluation is performed locally using policy data retrieved from the policy store (108), and the resulting execution governance decision is generated independently of any cloud-based processing.

In one embodiment, the policy store (108) further includes versioned policy metadata, integrity verification data, and policy scope attributes defining applicability of policies based on device state, user context, application context, execution environment, or operational conditions. Such metadata enables deterministic policy selection and repeatable execution governance outcomes under identical evaluation conditions.

In embodiments that include optional cloud-based components (109), the cloud-based components are configured solely to perform centralized policy orchestration, policy authoring, policy distribution, configuration management, or administrative oversight functions. Cloud-based components (109) do not participate in AI execution pathway determination, confidence scoring, attribution, execution governance decision-making, or enforcement actions.

In such embodiments, updated or modified policy definitions may be securely transmitted from the cloud-based components (109) to the policy store (108) using authenticated and integrity-verified update mechanisms. Once received, policy data is stored locally within the policy store (108) and evaluated exclusively by local execution governance logic. Loss of network connectivity or unavailability of cloud-based components (109) does not impair local AI execution governance, pathway determination, or enforcement functionality.

In one embodiment, the policy store (108) supports multiple policy profiles corresponding to different governance modes, including enterprise-managed policies, administrator-defined policies, regulatory compliance policies, or device-specific execution governance profiles. Selection among such policy profiles is performed locally and deterministically based on execution context and configured policy conditions.

Accordingly, the policy store (108) operates as a local authoritative source of machine-evaluable AI execution governance rules, while cloud-based components (109), when present, function only as non-enforcing orchestration and management services. This architectural separation ensures privacy preservation, deterministic enforcement, offline operability, and reduced attack surface.

Optional cloud-based components (109), when present, provide orchestration, policy distribution, configuration management, or centralized administration functions and do not perform execution enforcement or local execution control.

Execution governance decisions are determined based on AI-specific execution characteristics and execution context evidence derived from operating-system-level signals and are independent of static executable identifiers, including executable name, hash, certificate, or publisher identity.

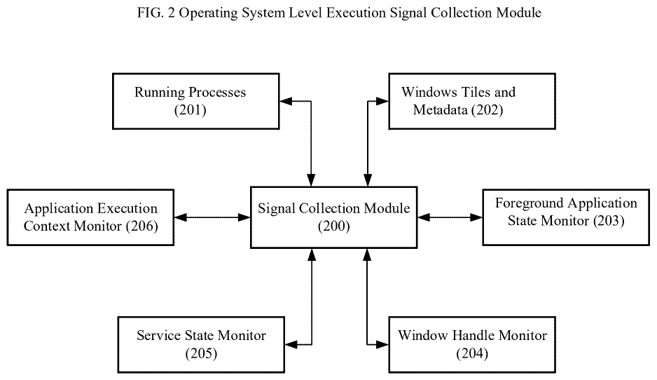

As illustrated in FIG. 2, the Signal Collection Module (200) is configured to collect operating-system-level execution signals generated locally by a computing device during application execution.

The operating-system-level execution signals may include, without limitation:
(a) Running Processes (201), including process creation events, process identifiers, parent-child process relationships, and process lifecycle transitions;
(b) Window Titles and Metadata (202), including window names, class identifiers, visibility attributes, and associated process bindings;
(c) Foreground Application State Monitor (203), configured to determine which application or process instance is actively presented to a user;
(d) Window Handle Monitor (204), configured to observe window handle creation, association, and focus transitions;
(e) Service State Monitor (205), configured to identify service initiation, suspension, termination, and privilege state changes; and
(f) Application Execution Context Monitor (206), configured to collect execution context attributes including runtime dependencies, invocation pathways, execution environments, and privilege contexts.

In one embodiment, “invocation pathway attributes” include machine-observable attributes indicative of how an AI-enabled function is invoked, including, without limitation, command-line parameters, parent-child process lineage, module or library call graph identifiers, inter-process communication endpoint identifiers, named pipe or socket endpoint identifiers, remote procedure call (RPC) interface identifiers, or application programming interface (API) invocation patterns mapped by policy to AI feature invocation.

All of the operating-system-level execution signals illustrated in FIG. 2 are generated inherently by the operating system during normal application execution and are collected by the Signal Collection Module (200) without inspecting application content, user input, prompts, responses, network traffic, or AI-generated output.

The collected execution signals provide contextual information sufficient to support downstream determination of whether AI execution is occurring or has been attempted, and to enable policy-based execution governance decisions without reliance on content inspection, payload analysis, behavioral malware heuristics, or threat classification.

AI execution indicators derived by the Evidence Generation Module (102) may include execution behaviors, invocation contexts, runtime dependencies, or execution pathways characteristic of AI-enabled functionality, as inferred from the operating-system-level execution signals collected by the Signal Collection Module (200).

In one embodiment, “AI execution indicators” comprise machine-evaluable features derived from normalized operating-system-level execution signals, the features including at least one of: (i) a parent-child process lineage feature indicating that a host process spawned an auxiliary process within the bounded temporal evaluation window; (ii) a dependency-family feature indicating that a process loaded at least one module mapped to a policy-defined AI runtime dependency family; (iii) a service-interaction feature indicating start, bind, or use of an AI-associated broker service or feature host; (iv) an invocation-path feature indicating a call chain, command-line pattern, IPC endpoint, or API usage pattern mapped to AI invocation; and (v) a temporal-sequence feature indicating satisfaction of ordering constraints and temporal correlation constraints among the foregoing features.

In one embodiment, the confidence scoring engine assigns weights to such features using a policy-defined weight table, where each feature weight is a numeric value, and the aggregated score is normalized into a bounded range (e.g., 0 to 1 or 0 to 100) for deterministic threshold comparison.

In all embodiments, the operating-system-level execution signals collected by the Signal Collection Module are normalized into a canonical representation prior to pathway determination. Normalization ensures that equivalent execution behaviors produce identical normalized signal sets regardless of executable name, file hash, version, or installation path.

In all embodiments, determination of whether an AI Execution Pathway exists is performed exclusively through satisfaction of a mandatory signal set, ordering constraints, temporal correlation constraints, and exclusion conditions defined by a machine-evaluable execution pattern definition. Confidence scoring is not used to determine presence or absence of an AI Execution Pathway and does not cause a pathway match. Confidence scoring is applied only after a binary pathway match outcome is determined, solely for selecting among enforcement actions or governance responses following such determination.

In all embodiments, the determination of whether an AI Execution Pathway exists is based on operating-system-level execution signals collected during application execution and does not rely on application identity, executable name, file hash, certificate, publisher, or reputation attributes. The execution signals are collected locally by the Signal Collection Module and include process, window, service, and execution context attributes generated inherently by the operating system.

The operating-system-level execution signals are normalized into a canonical representation prior to pathway determination such that equivalent execution behaviors produce identical normalized signal sets regardless of executable version, installation path, or runtime environment. This normalization enables deterministic evaluation of AI execution behavior across different applications and execution contexts.

AI execution indicators are derived from the normalized operating-system-level execution signals and comprise machine-evaluable features indicative of AI-enabled execution behavior. Such features may include, without limitation, parent-child process lineage attributes, runtime dependency loading attributes associated with policy-defined AI runtime dependency families, service interaction attributes associated with AI feature brokers or execution hosts, invocation pathway attributes, and temporal-sequence attributes reflecting ordering and timing relationships among execution signals.

Determination of the AI Execution Pathway is performed by evaluating the derived AI execution indicators against a machine-evaluable execution pattern definition comprising a mandatory signal set, ordering constraints, temporal correlation constraints, and one or more exclusion conditions evaluated within a bounded temporal evaluation window. Satisfaction of the mandatory signal set and associated constraints produces a binary pathway match outcome, and failure to satisfy any mandatory requirement produces a non-match outcome.

Confidence scoring, when employed, is applied only after a binary pathway match outcome has been determined and is used solely to select among enforcement actions or governance responses. Confidence scoring does not determine whether an AI Execution Pathway exists and does not cause a pathway match to occur.

Execution governance decisions generated by the Execution Control Engine are therefore based on deterministic evaluation of normalized operating-system-level execution signals and bounded execution pattern definitions rather than on probabilistic analysis, content inspection, payload inspection, behavioral malware heuristics, or static executable identification.

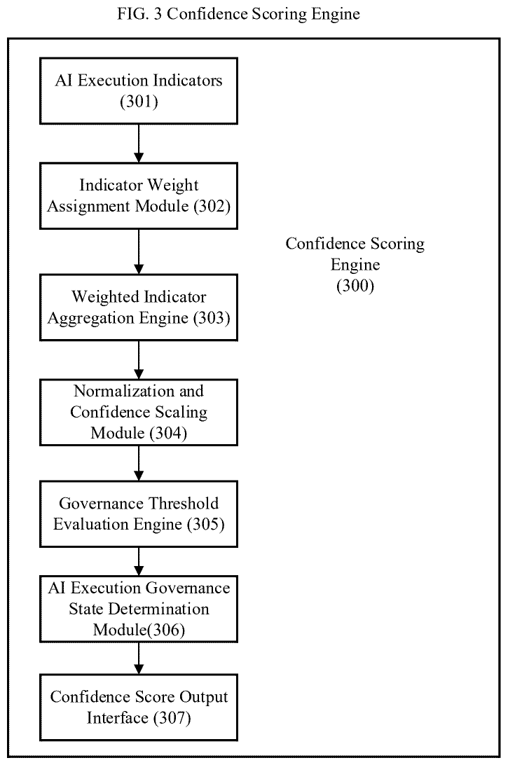

As illustrated in FIG. 3, the Confidence Scoring Engine (300) generates a normalized confidence score representing relative evidentiary strength of AI execution indicators after an AI Execution Pathway has been evaluated. The confidence score is used as an intermediate value for selecting among multiple enforcement or governance responses after a pathway match has been determined and does not itself determine whether an AI Execution Pathway exists.

In the exemplary embodiment shown, individual AI execution indicators (301) are provided to an Indicator Weight Assignment Module (302), which applies predefined or configurable weighting values corresponding to the relative evidentiary significance of each indicator. The weighted indicators are combined by a Weighted Indicator Aggregation Engine (303) to produce an aggregated confidence representation indicative of AI execution likelihood.

The aggregated confidence representation is processed by a Normalization and Confidence Scaling Module (304) to generate a normalized confidence value within a consistent scoring range, thereby enabling deterministic comparison across different operating environments, applications, and execution contexts.

The normalized confidence value is evaluated by a Governance Threshold Evaluation Engine (305), which compares the confidence value against one or more configurable governance thresholds corresponding to distinct AI execution control conditions. When one or more threshold conditions are satisfied, an AI Execution Governance State Determination Module (306) identifies a corresponding execution governance state, including but not limited to permitted execution, conditional execution, restricted execution, prevented execution, or enforcement escalation.

All governance states determined by the Confidence Scoring Engine and Execution Control Engine correspond to concrete operating-system-level execution control outcomes and are not advisory in nature. Each governance state, when selected, results in generation of a machine-enforceable execution control instruction that causes the operating system to modify execution state of an AI-associated execution context, except in identification-only embodiments explicitly described herein.

The resulting confidence values and determined AI execution governance state are provided via a Confidence Score Output Interface (307) to downstream system components, including the Execution Control Engine (105) and Enforcement Module (106), enabling pre-execution prevention, in-execution restriction, or enforcement escalation actions to be performed locally on the computing device.

The Confidence Scoring Engine (103) improves computer operation by reducing unnecessary execution control actions while enabling precise, policy-driven enforcement of AI execution governance.

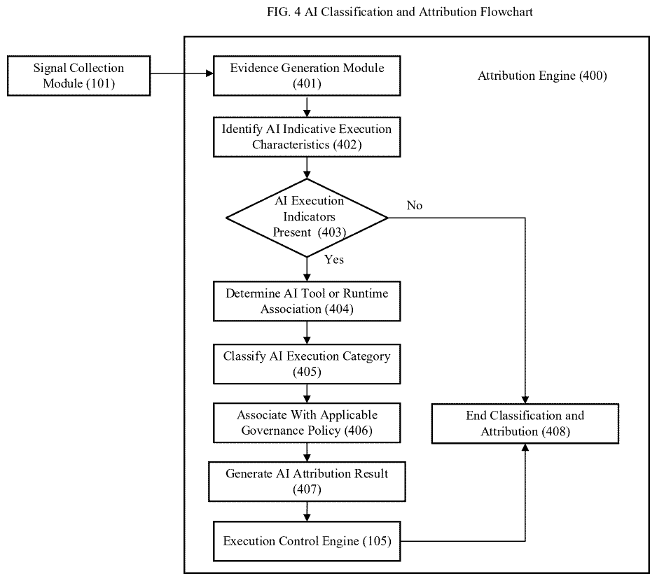

As illustrated in FIG. 4, the Attribution Engine (104) performs AI tool classification and prevention attribution through a structured execution-evidence evaluation flow that associates observed execution behavior with artificial intelligence tools, AI functional categories, or AI execution patterns for governance determination.

In the exemplary embodiment shown, the attribution flow begins by receiving execution evidence from the Evidence Generation Module (401). The received execution evidence comprises AI execution indicators derived from operating-system-level execution signals collected locally by the Signal Collection Module (101, 200).

Upon receipt of the execution evidence, the Attribution Engine (104) identifies AI-indicative execution characteristics (402). Such characteristics may include execution pathways, runtime dependency loading behavior, invocation context attributes, service interaction patterns, or other execution behaviors characteristic of AI-enabled functionality, derived exclusively from operating-system-level execution signals as previously described.

Following identification of AI-indicative execution characteristics, the Attribution Engine (104) evaluates whether one or more AI execution indicators are present by performing a decision operation (403).

Attribution and classification performed by the Attribution Engine occur only after an AI Execution Pathway has been identified or partially identified through execution-context evaluation, and do not independently trigger enforcement actions.

If the decision operation (403) determines that AI execution indicators are not present, the attribution workflow terminates by routing directly to end classification and attribution flow (408) without generating an AI attribution result.

If the decision operation (403) determines that AI execution indicators are present, the attribution workflow proceeds to determine an AI tool or runtime association (404). In this step, the Attribution Engine (104) associates the identified execution characteristics with a known AI tool, AI runtime environment, embedded AI component, or AI-associated execution context, without reliance on executable identity, binary signatures, or publisher information.

Following determination of AI tool or runtime association (404), the Attribution Engine (104) classifies the AI execution category (405). AI execution categories may include, without limitation, generative AI execution, inference execution, embedded AI assistance, model training activity, or other AI functional classifications relevant to governance policy evaluation.

The classified AI execution category is then evaluated to associate the observed execution pattern with an applicable governance policy (406). In this step, execution characteristics and AI classification results are mapped to one or more policy definitions that govern whether AI execution is permitted, conditionally allowed, restricted, sandboxed, or prohibited under current governance conditions.

Upon completion of policy association, the Attribution Engine (104) generates an AI attribution result for the Execution Control Engine (407). The AI attribution result may include, without limitation, an AI tool identifier, AI execution category, execution pattern classification, and policy association metadata sufficient to support downstream execution governance decisions.

The AI attribution result generated at (407) is provided as an output to downstream execution control logic, including the Execution Control Engine (105), enabling deterministic, policy-driven execution control decisions to be made locally on the endpoint computing device.

The attribution workflow terminates upon completion of the attribution process by reaching end classification and attribution flow (408).

At all stages illustrated in FIG. 4, AI tool classification and prevention attribution are derived exclusively from operating-system-level execution signals and execution-context evidence, thereby preserving user privacy while enabling deterministic AI execution governance.

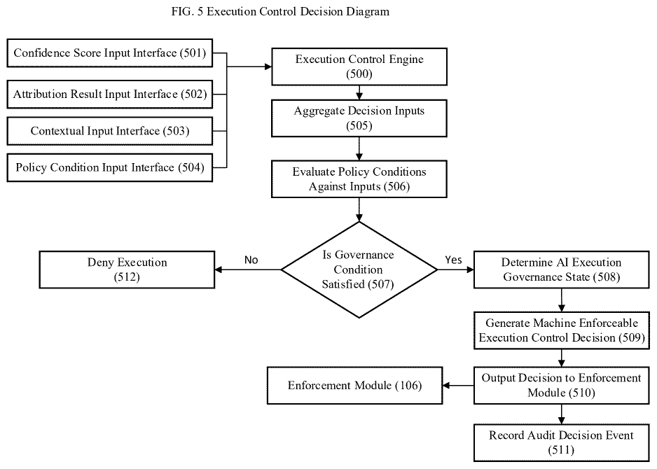

As illustrated in FIG. 5, the Execution Control Engine (500) implements a structured decision model configured to generate machine-enforceable artificial intelligence (AI) execution governance decisions based on multiple independently derived inputs.

The Execution Control Engine (500) generates execution governance decisions only after a binary AI Execution Pathway match outcome has been determined. Confidence scores, attribution results, and contextual inputs are evaluated solely to select an appropriate governance state or enforcement action following a pathway match, and do not independently cause enforcement.

In the exemplary embodiment shown, the Execution Control Engine (500) receives a normalized confidence score via a Confidence Score Input Interface (501) from the Confidence Scoring Engine (103), an AI attribution result via an Attribution Result Input Interface (502) from the Attribution Engine (104), contextual execution information via a Contextual Input Interface (503), and applicable governance rules and constraints via a Policy Condition Input Interface (504).

The received inputs are provided to an Aggregate Decision Inputs module (505), which combines confidence values, attribution metadata, contextual attributes, and policy conditions into a unified decision input set. The aggregated decision inputs are evaluated by an Evaluate Policy Conditions Against Inputs module (506), which compares the aggregated inputs against one or more configured governance policies to determine whether an AI execution governance condition is satisfied.

Following evaluation, a decision operation is performed at Decision block (507) to determine whether the governance condition is satisfied. If the governance condition is not satisfied, the execution control logic routes directly to a Deny Execution output (512), permitting AI execution to proceed without restriction.

If the governance condition is satisfied at decision block (507), the Execution Control Engine (105) transitions to a Determine AI Execution Governance State module (508). In this step, a specific AI execution governance state is selected based on policy conditions, confidence thresholds, attribution results, and contextual inputs.

Non-limiting governance state outputs determined by module (508) may include Restrict Execution, Require User Confirmation or Justification, Sandbox or Constrain Execution Environment, Block Execution, or Escalate to Admin or Enterprise Policy Service. One or more of these governance state outputs may be selected depending on policy configuration and execution context.

The selected governance state is then translated into a machine-enforceable execution control instruction by a Generate Machine-Enforceable Execution Control Decision module (509). The generated execution control decision is transmitted via an Output Decision to Enforcement Module interface (510) to the Enforcement Module (106) for application of operating-system-level execution control mechanisms.

In all embodiments, the execution control decision generated by module (509), regardless of whether AI execution is allowed, restricted, or prevented, is recorded via an Audit Decision Event/Decision Logging Interface (511). Machine-enforceable execution control instructions may include, without limitation, operating-system-level process creation blocking, thread suspension, privilege revocation, execution sandboxing, or service disablement. In one embodiment, the machine-enforceable execution control instruction triggers a concrete operating-system control operation that changes execution behavior on the computing device, including at least one of: preventing creation of an AI-associated process using an operating-system process creation interception mechanism; suspending one or more AI-associated threads; revoking or constraining an access token or privilege used to access an AI runtime resource; applying an execution sandbox or constrained security profile to an AI-associated process; or disabling an AI-associated service through an operating-system service control interface.

In one embodiment, the machine-enforceable execution control instruction is applied using operating-system execution control facilities that directly modify execution state of a process, thread, service, or privilege context. Non-limiting implementations include: (i) pre-execution process creation gating that prevents creation of an AI-associated process prior to initialization; (ii) in-execution thread suspension or resumption for AI-associated threads; (iii) privilege or access-token modification that constrains access to AI runtime resources; (iv) application of a constrained execution profile or sandbox policy to an AI-associated process; and (v) service control operations that stop or disable an AI-associated broker service or feature host.

In one embodiment, the foregoing execution control mechanisms are invoked in response to an AI Execution Pathway match determined within a bounded temporal evaluation window using a mandatory signal set and an exclusion condition, such that execution control is applied to an execution context identified as AI-associated while permitting non-AI functionality of a host application session to continue executing.

Accordingly, the disclosed execution control decision is not merely a policy recommendation or advisory output, but results in an operating-system-enforced modification of execution state and resource access on the endpoint computing device.

The audit record may include decision inputs, policy identifiers, confidence values, attribution metadata, and selected governance state to support compliance, review, or forensic analysis.

The execution control logic illustrated in FIG. 5 enables deterministic, policy-driven AI execution governance decisions to be generated locally on the endpoint computing device. Execution control decisions may be generated prior to execution, during execution, or upon attempted execution of AI-associated functionality in accordance with the execution pathway evaluation mechanisms described herein.

Execution control decisions illustrated in FIG. 5 are generated following a binary AI Execution Pathway match outcome, with confidence values and policy conditions applied only as described above to select among enforcement actions, thereby preserving deterministic execution governance behavior.

The system maintains one or more AI execution governance states associated with a device, user session, application instance, or execution context as determined by the Execution Control Engine (105). Each governance state defines the execution conditions applied to AI tools.

The AI execution governance states described herein represent persistent execution control conditions maintained by the system across an execution context, device, or session, and are distinct from individual enforcement outputs or control actions generated for a specific AI execution attempt.

Non-limiting examples of AI execution governance states include: AI-Execution-Allowed; AI-Execution-Monitor-Only; AI-Execution-Restricted; AI-Execution-Prohibited; AI-Execution-Enforcement-Active; AI-Execution-Audit-Only; and AI-Execution-Identified.

In the AI-Execution-Identified governance state, the system has determined that an AI Execution Pathway is present or has been attempted, but no operating-system-level execution control action is applied.

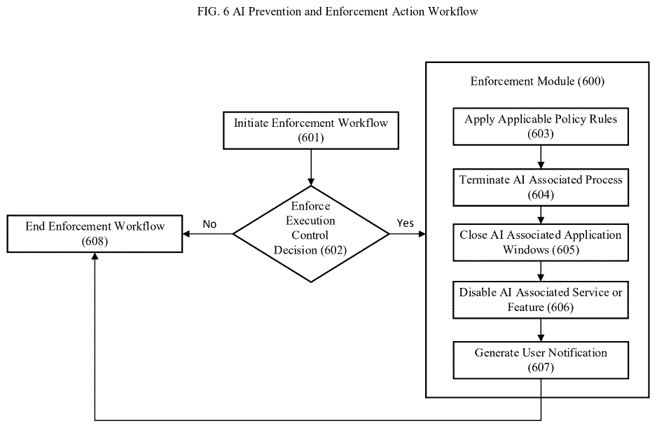

As illustrated in FIG. 6, the Enforcement Module (600) executes AI prevention and enforcement actions in response to an execution control decision generated by the Execution Control Engine (105).

Enforcement begins upon initiation of an enforcement workflow (601). At step (602), the Enforcement Module determines whether the received execution control decision requires enforcement. If enforcement is not required, the enforcement workflow terminates without action (608).

If enforcement is required, the Enforcement Module applies applicable policy rules (603) and performs one or more operating-system-level enforcement actions, including terminating an AI-associated process (604), closing an associated application window (605), or disabling an AI-associated service, feature, or execution capability (606).

In one embodiment, a user notification is generated (607). The enforcement workflow then terminates (608).

Enforcement actions are applied only to AI-associated execution contexts determined to satisfy a pathway match and are performed without reliance on content inspection or network visibility, as previously described.

The modules and workflows described herein may be implemented, in whole or in part, using one or more of kernel-level components, user-mode services, operating-system APIs, execution hooks, or hardware-assisted enforcement mechanisms, and may be adapted for different operating systems or execution environments without departing from the scope of the invention.

The invention may be implemented across desktops, laptops, virtual machines, and managed enterprise platforms. Execution scoring models, governance states, and enforcement actions may be customized to accommodate different operating environments, performance requirements, or governance objectives without departing from the scope of the invention.

In embodiments where cloud-based or SaaS components are used, their role is strictly limited to orchestration, policy distribution, or centralized management. These components do not participate in execution governance or enforcement actions. All decisions regarding AI execution pathway control are made locally on the endpoint computing device, ensuring privacy, low-latency enforcement, and compatibility with air-gapped environments.

The foregoing detailed description has been presented for purposes of illustration and description and is not intended to be exhaustive or to limit the invention to the precise forms disclosed. Modifications, variations, substitutions, and combinations may be made to the disclosed embodiments without departing from the spirit and scope of the invention.

The embodiments described herein were chosen and described in order to best explain the principles of the invention and its practical application, thereby enabling others skilled in the art to understand the invention for various embodiments and with various modifications as are suited to the particular use contemplated.

In the following claims, the terms used should not be construed to limit the claims to the specific embodiments disclosed in the specification, but should be construed to include all embodiments and equivalents that fall within the scope of the claims as defined by the appended claims and their equivalents under applicable law. Accordingly, the claims are not limited by the disclosure.

1. A method for improving operation of a computing device by preventing, restricting, or conditionally controlling execution of artificial intelligence (AI) functionality at an operating-system level, the method comprising:
(a) collecting operating-system-level execution signals during application execution, the operating-system-level execution signals including at least process creation events and execution context attributes including at least one of runtime dependency load attributes, privilege context attributes, invocation pathway attributes, or service interaction attributes;
(b) accessing a policy store that defines an AI execution pathway as a machine-evaluable execution pattern definition comprising: a trigger event type, a bounded temporal evaluation window, a mandatory signal set, ordering constraints, temporal correlation constraints, and an exclusion condition;
(c) responsive to detecting the trigger event type, initiating the bounded temporal evaluation window and determining a binary pathway match outcome by verifying observation of the mandatory signal set within the bounded temporal evaluation window, verifying satisfaction of the ordering constraints and the temporal correlation constraints, and rejecting the pathway match when the exclusion condition is satisfied;
(d) generating AI execution indicators from normalized operating-system-level execution signals observed within the bounded temporal evaluation window;
(e) generating a normalized confidence score from the AI execution indicators, wherein the normalized confidence score is used as an intermediate value to select among a plurality of enforcement actions after the binary pathway match outcome indicates a match;
(f) only after the binary pathway match outcome indicates a match, generating a machine-enforceable execution control instruction configured to modify execution state of at least one execution context determined to satisfy the pathway match;
(g) applying the machine-enforceable execution control instruction via a kernel-mediated execution control interface using a two-phase execution gate comprising:
(i) prior to completion of initialization of a child process associated with the trigger event type, placing the child process into a blocked, delayed-start, or suspended state while the bounded temporal evaluation window is evaluated; and
(ii) responsive to the binary pathway match outcome indicating a match, applying at least one of privilege demotion, access token constraint, sandbox profile application, service disablement, or thread suspension to constrain AI-enabled execution; and
(h) preserving host application operation by applying the machine-enforceable execution control instruction to an AI-associated execution context determined to satisfy the pathway match without terminating a host application process, by correlating at least a parent-child process lineage, a runtime dependency load attribute matching a policy-defined AI runtime dependency family, and a service interaction attribute indicating activation or use of an AI-associated broker service or feature host.

2. A system for improving operation of a computing device by preventing, restricting, or conditionally controlling execution of artificial intelligence (AI) functionality at an operating-system level, the system comprising:
(a) a signal collection module executed by the computing device and configured to intercept and collect operating-system-level execution signals generated by an operating system during application execution, the operating-system-level execution signals including at least process creation events and execution context attributes including at least one of runtime dependency load attributes, privilege context attributes, invocation pathway attributes, or service interaction attributes;
(b) a policy store comprising one or more machine-readable policy definitions that define an AI execution pathway as a machine-evaluable execution pattern definition comprising:
(i) at least one trigger event type that initiates evaluation;
(ii) a bounded temporal evaluation window having a defined start time relative to the trigger event type;
(iii) a mandatory signal set comprising two or more operating-system-level execution signals;
(iv) ordering constraints defining permitted sequences among signals in the mandatory signal set;
(v) temporal correlation constraints defining permitted time deltas among signals in the mandatory signal set; and
(vi) at least one exclusion condition that negates a match when satisfied;
(c) an evidence generation module configured to normalize the operating-system-level execution signals and to map the normalized operating-system-level execution signals into one or more AI execution indicators;
(d) a pathway match engine configured, responsive to detecting an occurrence of the trigger event type, to initiate the bounded temporal evaluation window and to determine a binary pathway match outcome for the AI execution pathway by:
(i) verifying that each signal in the mandatory signal set is observed within the bounded temporal evaluation window;
(ii) verifying satisfaction of the ordering constraints and the temporal correlation constraints; and
(iii) rejecting the pathway match when the exclusion condition is satisfied;
(e) a confidence scoring engine configured to assign weighted values to the AI execution indicators observed within the bounded temporal evaluation window to generate a normalized confidence score, wherein the normalized confidence score is used as an intermediate value for selecting among a plurality of enforcement actions after the binary pathway match outcome indicates a match, without determining whether the pathway match outcome occurs;
(f) an execution control engine configured, only after the pathway match engine determines that the binary pathway match outcome indicates a match, to generate a machine-enforceable execution control instruction configured to modify execution state of at least one execution context determined to satisfy the pathway match; and
(g) an enforcement module configured to apply the machine-enforceable execution control instruction using a kernel-mediated execution control interface to perform an operating-system-level control operation comprising at least one of: preventing creation of an AI-associated process, suspending one or more AI-associated threads, revoking or constraining a privilege used to access an AI runtime resource, applying a constrained execution profile to an AI-associated process, or disabling an AI-associated service or execution feature;
wherein the system is configured to improve computer operation, at least in part, by executing a two-phase execution gate comprising:
(i) a pre-initialization gate that, responsive to detecting the trigger event type and prior to completion of initialization of a child process, places the child process into a blocked, delayed-start, or suspended state that prevents completion of initialization while the bounded temporal evaluation window is evaluated; and
(ii) an in-execution gate that, responsive to the binary pathway match outcome indicating a match, applies at least one of privilege demotion, access token constraint, sandbox profile application, service disablement, or thread suspension to prevent or constrain AI-enabled execution;
wherein the system is configured to preserve host application operation by applying the operating-system-level control operation to an AI-associated execution context determined to satisfy the pathway match without terminating a host application process, by correlating at least:
(1) a parent-child process lineage between a host application process and an auxiliary process;
(2) a runtime dependency load attribute matching a policy-defined AI runtime dependency family; and
(3) a service interaction attribute indicating activation or use of an AI-associated broker service or feature host;
and wherein the machine-enforceable execution control instruction is not advisory and causes the operating system to enforce a state change that prevents, delays, suspends, constrains, or selectively terminates execution of the AI-associated execution context.

3. The system of claim 2, wherein the operating-system-level execution signals further include at least one of window titles or window metadata, foreground application state, window handle activity, or service state transitions.

4. The system of claim 2, wherein the AI execution pathway is identifiable when AI functionality is embedded within an application that provides non-AI functionality and that invokes AI functionality through at least one of a plug-in, auxiliary service, development tool component, or operating-system component.

5. The system of claim 2, wherein the confidence scoring engine normalizes the confidence score to a consistent scoring range and compares the confidence score to a plurality of governance thresholds corresponding to different AI execution governance states.

6. The system of claim 2, wherein the AI execution governance state comprises at least one of: allow execution, monitor-only, restricted execution, conditional execution, sandboxed execution, prohibited execution, or enforcement escalation.

7. The system of claim 2, wherein the machine-enforceable execution control instruction includes at least one of: blocking process creation, suspending a thread, revoking a privilege, disabling a service, constraining an execution environment, or terminating a process.

8. The system of claim 2, wherein the execution control engine generates the machine-enforceable execution control instruction prior to initialization of an AI-associated process.

9. The system of claim 2, wherein the execution control engine generates the machine-enforceable execution control instruction during execution of an application based on a change in operating-system-level execution signals indicating invocation of the AI execution pathway.

10. The system of claim 2, further comprising an audit logging interface configured to record, for an execution control decision, at least one of: a policy identifier, the confidence score, the AI attribution result, contextual inputs, or the AI execution governance state.

11. The system of claim 2, further comprising a user interface module configured to output a user-visible notification indicating that AI execution has been restricted, prevented, sandboxed, or modified.

12. The system of claim 2, wherein the system is configured such that identical operating-system-level execution signals and policy conditions produce an identical AI execution governance state and an identical machine-enforceable execution control instruction, independent of executable hash, executable name, certificate, or publisher identity.

13. The system of claim 2, further comprising a cloud-based policy distribution component configured to distribute governance policies or configuration to the computing device, wherein the cloud-based policy distribution component lacks access to operating-system execution control interfaces.

14. The system of claim 2, further comprising instructions that, when executed, cause performance of the method of claim 1.

15. The method of claim 1, further comprising recording an audit record comprising at least the confidence score, a policy identifier, and the AI execution governance state.

16. The method of claim 1, wherein applying comprises blocking process creation prior to initialization of an AI-associated process.

17. The method of claim 1, wherein applying comprises disabling an AI-associated service or feature using an operating-system service control mechanism.

18. The method of claim 1, wherein determining comprises comparing the confidence score to a plurality of governance thresholds corresponding to different governance states.

19. The method of claim 1, further comprising outputting a user-visible notification indicating an enforcement action was applied.

20. A non-transitory computer-readable medium storing instructions that, when executed by one or more processors of a computing device, cause the computing device to improve operation of the computing device by preventing, restricting, or conditionally controlling execution of artificial intelligence (AI) functionality at an operating-system level, the instructions causing the computing device to perform operations comprising:
(a) collecting operating-system-level execution signals during application execution, the operating-system-level execution signals including at least process creation events and execution context attributes including at least one of runtime dependency load attributes, privilege context attributes, invocation pathway attributes, or service interaction attributes;
(b) accessing a policy store that defines an AI execution pathway as a machine-evaluable execution pattern definition comprising: a trigger event type, a bounded temporal evaluation window, a mandatory signal set, ordering constraints, temporal correlation constraints, and an exclusion condition;
(c) responsive to detecting the trigger event type, initiating the bounded temporal evaluation window and determining a binary pathway match outcome by verifying observation of the mandatory signal set within the bounded temporal evaluation window, verifying satisfaction of the ordering constraints and the temporal correlation constraints, and rejecting the pathway match when the exclusion condition is satisfied;
(d) generating AI execution indicators from normalized operating-system-level execution signals observed within the bounded temporal evaluation window;
(e) generating a normalized confidence score from the AI execution indicators, wherein the normalized confidence score is used as an intermediate value to select among a plurality of enforcement actions after the binary pathway match outcome indicates a match;
(f) only after the binary pathway match outcome indicates a match, generating a machine-enforceable execution control instruction configured to modify execution state of at least one execution context determined to satisfy the pathway match;
(g) applying the machine-enforceable execution control instruction via a kernel-mediated execution control interface using a two-phase execution gate comprising:
(i) prior to completion of initialization of a child process associated with the trigger event type, placing the child process into a blocked, delayed-start, or suspended state while the bounded temporal evaluation window is evaluated; and
(ii) responsive to the binary pathway match outcome indicating a match, applying at least one of privilege demotion, access token constraint, sandbox profile application, service disablement, or thread suspension to constrain AI-enabled execution; and
(h) preserving host application operation by applying the machine-enforceable execution control instruction to an AI-associated execution context determined to satisfy the pathway match without terminating a host application process, by correlating at least a parent-child process lineage, a runtime dependency load attribute matching a policy-defined AI runtime dependency family, and a service interaction attribute indicating activation or use of an AI-associated broker service or feature host.

21. The system of claim 2, wherein determining the pathway match for the AI execution pathway comprises evaluating a mandatory signal set within the defined temporal evaluation window and rejecting the pathway match when an exclusion condition is satisfied.

22. The method of claim 1, wherein the policy store defines a plurality of AI execution pathway rule sets corresponding to different AI execution categories, each rule set comprising a distinct mandatory signal set and exclusion condition.

23. A system for identifying artificial intelligence (AI) execution on a computing device, the system comprising:
(a) a signal collection module configured to collect operating-system-level execution signals generated during application execution, the execution signals comprising at least process creation events and execution context attributes including at least one of runtime dependency load attributes, invocation pathway attributes, privilege context attributes, or service interaction attributes;
(b) a policy store comprising one or more machine-readable policy definitions that define an AI execution pathway as a machine-evaluable execution pattern comprising:
(i) at least one trigger event type;
(ii) a bounded temporal evaluation window;
(iii) a mandatory signal set comprising two or more operating-system-level execution signals;
(iv) ordering constraints defining permitted signal sequences;
(v) optionally, temporal correlation constraints defining permitted time deltas among signals; and
(vi) at least one exclusion condition;
(c) a pathway determination engine configured, responsive to detection of the trigger event type, to evaluate the operating-system-level execution signals observed within the bounded temporal evaluation window against the policy definitions and to determine a binary pathway match outcome indicating presence or absence of the AI execution pathway; and
(d) an identification output interface configured to generate an AI execution identification result indicative of at least one of:
(i) presence of AI execution,
(ii) absence of AI execution, or
(iii) classification of AI execution by category or execution pattern;
wherein the system is configured to identify AI execution without applying an operating-system-level execution control or enforcement action.

24. The system of claim 2, wherein the execution control engine is further configured to identify and classify execution of artificial intelligence functionality based on the pathway match outcome when no machine-enforceable execution control instruction is generated.

25. A method for identifying artificial intelligence (AI) execution on a computing device, the method comprising:
(a) collecting operating-system-level execution signals during application execution;
(b) initiating a bounded temporal evaluation window in response to a trigger event;
(c) evaluating the execution signals against a machine-evaluable AI execution pathway definition comprising a mandatory signal set, ordering constraints, and an exclusion condition; and
(d) determining, based on the evaluation, a binary AI execution identification result indicating presence or absence of AI execution;
wherein the method is performed without applying an operating-system-level execution control action.

26. The system of claim 2, wherein determining the AI execution pathway does not require identification of a specific artificial intelligence model, machine learning model, algorithm, framework, vendor, executable binary, library signature, model artifact, or training dataset.

27. The system of claim 2, wherein the operating-system-level control operation comprises selectively suspending, resuming, throttling, or modifying scheduling priority of one or more threads associated with AI-enabled execution while permitting other threads of the same host application process to continue execution.

28. The system of claim 2, wherein the machine-enforceable execution control instruction is generated and applied independent of any determination of maliciousness, exploit behavior, vulnerability, or security threat classification.
